(19) United States
(12) Patent Application Publication
(10) Pub. No.: US 2008/0175392 A1
(43) Pub. Date: Jul. 24, 2008

(54) Image processing device

(76) Inventors: Shinya Ogura, Tokyo (JP); Seiichi Hirai, Tokyo (JP); Munemitsu Kuwabara, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,550

(22) Filed: Jan. 11, 2008

(30) Foreign Application Priority Data
Jan. 15, 2007 (JP) 2007-005284

(51) Int. Cl. H04L 9/08

(52) U.S. Cl. 380/278

(57) ABSTRACT

An image processing device having an improved configuration for holding a key used for encryption is provided. An image processing device for encrypting image data using an encryption key, includes a first storage in which stored information is lost when the image processing device is powered off, and for storing presently used key data, a second storage in which stored information is maintained when the image processing device is powered off, and for storing key data to be used in the future, and a controller, in response to the image processing device being switched from a power-off state to a power-on state, for transferring the key data stored in the second storage and to be used next to the first storage to be stored in the first storage.

### BACKGROUND OF THE INVENTION

1. Technical Field

The present invention relates to a video image processing device of an image delivery system for encrypting and recording a video image (an image) shot by an imaging apparatus such as a monitoring camera, and transmits the video image via a network, in particular to a video image processing device having an improved configuration for holding a key used for the encryption.

2. Related Art

In the past, in public facilities such as hotels, buildings, convenience stores, financial institutions, dams, or roads, there are installed video image monitoring systems for the purpose of crime deterrent or accident prevention. In the video image monitoring system, the monitoring target is shot by an imaging apparatus such as a camera, the shot image is transmitted to a monitoring center such as an administrative office or a security guards room, and the observer monitors the image to give caution or warning, or recording or storing the image according to the purpose or the necessity.

In recent years, in the field of such video image monitoring systems, popularization of network video monitoring system which digitizes the monitoring camera image and transmits the image via an IP network represented by the Internet to perform monitoring has been in progress.

In the network video monitoring system presently in the mainstream, live video images are delivered from an image transmission device connected to the monitoring camera to an image reception device via a network. This system is designed to be a system suitable for a form of monitoring in which a resident observer always monitors the delivered video images (and sounds) to take measures corresponding to the circumstances when a problem occurs.

On the other hand, as the video image monitoring, besides the “live monitoring” anchored by the live image monitoring described above, there also exits a form of monitoring of “recording monitoring” in which “the monitoring images are recorded or stored to be viewed going back in time when a problem occurs,” and there are customer needs for such “recording monitoring” mainly in the financial institutions or stores.

In the network image monitoring system, “an image accumulation/delivery server” capable of meeting the needs for such “recording monitoring”.

Further, in order for preventing leakage of images by eavesdropping or theft of recorded images, popularization of an encrypting network video monitoring system for encrypting the image data and the recorded images flowing on the network, thus making it possible to be viewed only by the image reception device having the key for decryption is in progress.

JP-A-2006-101398 discloses such related art.

FIG. 1 shows a configuration example of an image delivery system which can be used as the encrypting network video monitoring system as described above. It should be noted that FIG. 1 is also referred to in an embodiment of the present invention described later, and although the explanation will be presented with reference to FIG. 1 here for the sake of convenience of the explanation, there is no intension for unnecessarily limiting the scope of the present invention.

In the case in which the encryption processing is executed with symmetric key cryptography on the images transmitted from an image transmission device 2 via a network 11 or the images transmitted from an image generation device 3 using a video cable after the images have been received in an image accumulation/delivery server 4, the key to be used for the encryption processing should previously be set in the image accumulation/delivery server 4.

However, the image accumulation/delivery server 4 and a recording medium 5 are often disposed at the same location or in the same chassis as a unit, thus the risk of being stolen together with each other is high. Further, if the image accumulation/delivery server 4 and the recording medium 5 are stolen as described above, both the encrypted image data and the key data used for the encryption processing should fall into the hands of the person who has stolen the both, thus the encrypted image data should be decrypted by the person.

On the other hand, if the key data is held in a storage device (e.g., a volatile memory) in which the record is lost when turning the power off in, for example, the image accumulation/delivery server 4, the recorded key data disappears when the image accumulation/delivery server 4 is powered off for stealing the image accumulation/delivery server 4, and consequently, the key data can be prevented from falling into the hands of the person who has stolen the image accumulation/delivery server 4.

However, in this case, since the key data also disappears when the rightful user turns the power off, it is required to perform resetting of the key data from the outside after powering it on again, and the operation problematically becomes more complicated.

FIGS. 12A and 12B schematically show an example of an existing state of the key according to the related art. The horizontal axis represents time t.

FIG. 12A shows an existing state 201 of the key data on a volatile memory of the image accumulation/delivery server 4.

In the volatile memory of the image accumulation/delivery server 4, the key exists from when the key is initially set to when the power is turned off, and the key starts existing again after the resetting of the key is performed when the power is subsequently turned on. As described above, the resetting operation of the key is required after the rightful user turns the power off and then turns the power on.

FIG. 12B shows an existing state 202 of the key data in an image reception device 6.

In the image reception device 6, the key data continuously exists from when the key has initially been set.

### SUMMARY

The present invention is made in order for solving the past problem as described above, and has an object of providing an image processing device having an improved configuration for holding a key used for encryption.

As a specific example, the present invention has an object of eliminating a key resetting operation by a rightful user when the rightful user turns off and on the power. Further, the present invention has an object of preventing leakage of the key data used in the past even in the case in which the image processing device has been stolen.

In order for achieving the objects described above, according to the present invention, an image processing device for encrypting image data using an encryption key is arranged to have the following configuration.

A first storage in which stored information is lost when the image processing device is powered off, stores presently used key data. A second storage in which stored information is maintained when the image processing device is powered off, stores key data to be used in the future. A controller, in response to the image processing device being switched from a power-off state to a power-on state, transfers the key data stored in the second storage and to be used next to the first storage to be stored in the first storage.

Therefore, when the image processing device is switched from a power-off state to a power-on state, the key data to be used next is transferred from the second storage to the first storage to be used as the present key data, therefore, when, for example, the rightful user turns the power off and then on, resetting of the key by the user can be eliminated. Further, when the image processing device is switched from a power-on state to a power-off state, the key data used before is deleted (does not remain), thus even if the image processing device is stolen, the leakage of the key data used before can be prevented.

In this case, various kinds of encryption methods or encryption keys can be used. The key is used, for example, for encryption or decryption.

Further, various kinds of image data can be used, for example, still images or motion images can be used.

Further, in the image processing device, for example, the encrypted image data can be recorded on a recording media inside or outside of the device, or encrypted image data can be transmitted to other devices.

Further, switching between the power-on state and the power-off state of the image processing device can be performed by, for example, the user (human) operations, or alternatively, at a predetermined time point using a timer (automatically by the device), or switched if a predetermined condition is satisfied (automatically by the device).

Further, the storage in which the stored information is lost (is not maintained) when the image processing device is powered off, can be formed using a volatile memory.

Further, the storage in which the stored information is maintained (is not lost) when the image processing device is powered off, can be formed using a nonvolatile memory.

Further, as the number of keys of data to be used in the future and stored in the second storage, various numbers can be used, including one, for example, or plural numbers.

Further, if a plurality of keys of data to be used in the future is stored in the second storage, the order of use can be determined previously or at random, and are used in that order.

Further, in the case in which the key data stored in the second storage is transferred to the first storage and stored in the first storage, for example, the key data is removed from the second storage.

Further, as the method of setting a plurality of keys of data to be used sequentially every time the image processing device is switched from the power-off state to the power-on state, various methods can be used, for example, it can be designated arbitrarily by the user (human), or can be set by the device using a predetermined operation formula based on the condition set previously or at random.

As an example, the data as a result of an operation along a predetermined function using the key data used at the previous time as the input value is used as the key data to be used next. In this case, the first key data is set, for example, initially.

As another example, the key (master key) and a plurality of values are prepared initially. A processing result using the master key and each of the values is calculated for each of the values. The data of the value of the result of the operation along a predetermined function is calculated using the processing result as an input value, and the plurality of data thus calculated is used as the key data in a predetermined order. It should be noted that as the processing results using the master key and the values, for example, the results of combining the master key data and the data of the values (e.g., combining as bit values), or the results of adding (e.g., adding as numerical values) the master key and the values can be used.

Further, various functions can be used as the predetermined function, a one-way function such as a hash function can be used.

It should be noted that the present invention can be provided as a method, a program, a recording medium, and so on.

In the method according to the present invention, each means performs various kinds of processing in the device or the system.

The program according to the present invention is intended to be executed by a computer composing the system or the device, and various kinds of functions are realized by the computer.

The recording medium according to the present invention records the program to be executed by the computer forming the device or the system in a manner readable by the input means of the computer, and the present program makes the computer perform various kinds of processing (procedures).

As described hereinabove, according to the image processing device relating to the present invention, when the rightful user, for example, turns the power off and on, the resetting of the key by the user can be eliminated, and further, if the image processing device is stolen, the leakage of the key data used before can be prevented.

### BRIEF DESCRIPTION OF THE DRAWINGS

FIG. 1 is a diagram showing a configuration example of an image delivery system according to an embodiment of the invention.

FIGS. 2A through 2C are diagrams showing an example of existing state of the key in a start-up key calculation method.

FIG. 3 is a diagram showing an example of a procedure of a processing executed by an image accumulation/delivery server in the initial setting in the start-up key calculation method.

FIG. 4 is a diagram showing an example of a procedure of a processing executed by an image accumulation/delivery server when starting-up in the start-up key calculation method.

FIG. 5 is a diagram showing an example of a procedure of a processing executed by an image reception device in decrypting the encrypted data in the start-up key calculation method.

FIG. 6 is a diagram showing an example of correspondence between the number of times of execution of a one-way function of the key stored in the start-up key calculation method and a date of starting using the key for encryption.

FIGS. 7A through 7C are diagrams showing an example of existing state of the key in an initial setting key calculation method.

FIG. 8 is a diagram showing an example of a procedure of a processing executed by an image accumulation/delivery server in the initial setting in the initial setting key calculation method.

FIG. 9 is a diagram showing an example of a procedure of a processing executed by an image accumulation/delivery server when starting-up in the initial setting key calculation method.

FIG. 10 is a diagram showing an example of a procedure of a processing executed by an image reception device in decrypting the encrypted data in the initial setting key calculation method.

FIG. 11 is a diagram showing an example of correspondence between the character string used for calculating the key stored in the initial setting key calculation method and a date of starting using the key for encryption.

FIGS. 12A and 12B are diagrams showing an example of existing state of the key according to the related art.

### DESCRIPTION OF THE EMBODIMENTS

Embodiments according to the present invention will now be described with reference to the accompanying drawings.

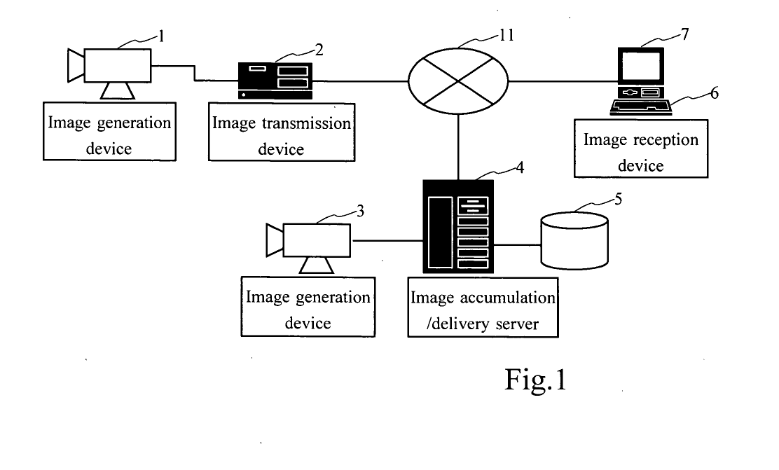

FIG. 1 shows a configuration example of an image delivery system according to an embodiment of the invention. The image delivery system according to the present embodiment is used as an encrypting network video monitoring system.

The image delivery system of the present embodiment is provided with an image generation device 1 mainly composed of a monitoring camera, an image transmission device 2, an image generation device 3 mainly composed of a monitoring camera, an image accumulation/delivery server (an image accumulation/delivery device) 4, a recording medium 5, an image reception device 6, an image display device 7, and a network (a network medium) 11.

The image transmission device 2, the image accumulation/delivery server 4, and the image reception device 6 are connected to the network 11.

It should be noted here that the image reception device 6 and the image display device 7 can be configured using, for example, a personal computer (PC).

An example of an operation executed in the image delivery system of the present embodiment will hereinafter be described.

The image generation device 1 shoots an image of, for example, a target of monitoring, and outputs the image to the image transmission device 2.

The image transmission device 2 transmits the image data input from the image generation device 1 to the network 11. The image data is transmitted, for example, to the image accumulation/delivery server 4 or the image reception device 6.

The image generation device 3 shoots the image, for example, of the monitoring target (a different one from the monitoring target of the image generation device 1 in the present embodiment), and outputs the image to the image accumulation/delivery server 4.

The image accumulation/delivery server 4 records the image data input from the image generation device 3 on the recording medium 5, and also records the image data received from the image transmission device 2 via the network 11 on the recording medium 5.

Further, in response, for example, to receiving a request for the image data from the image reception device 6 via the network 11, the image accumulation/delivery server 4 retrieves the required image data from the recorded contents of the recording medium 5, and transmits the image data to the image reception device 6 via the network 11. As another specific example, a configuration in which the image accumulation/delivery server 4 transmits the image data recorded on the recording medium 5 to the image reception device 6 (without the request) can be adopted.

The image reception device 6 receives the image data transmitted from the image transmission device 2 or the image data transmitted from the image accumulation/delivery server 4 via the network 11, and outputs the image data to the image display device 7.

Further, the image reception device 6 is provided with an operation section such as a keyboard or a mouse for receiving a request for an image, for example, from the user (a human), and transmits the received request for the image to the image accumulation/delivery server 4 via the network 11.

It should be noted that the part of the video image to be the target of the request can be specified using, for example, a time point or a frame number attached to the video image data.

The image display device 7 displays the image data input from the image reception device 6 on a screen.

Encryption of the image data will hereinafter be described.

In the present embodiment, the image accumulation/delivery server 4 is provided with a volatile memory and a nonvolatile memory, and stores the key data of the symmetric key cryptography in the volatile memory or the nonvolatile memory. Further, the image accumulation/delivery server 4 performs encryption of the image data using the key data stored in the volatile memory, and then records the encrypted image data on the recording medium 5. Further, the image accumulation/delivery server 4 transmits the encrypted image data (encrypted data) to the image reception device 6.

Further, the image accumulation/delivery server 4 has a function of accepting the key data designated, for example, by the operation of the user directly or indirectly via an external device, and stores (sets) the accepted key data in the volatile memory or the nonvolatile memory.

Here, the data stored in the volatile memory is deleted when the power supply to the image accumulation/delivery server 4 is stopped (the power is turned off), on the contrary, the data stored in the nonvolatile memory is held even when the power supply to the image accumulation/delivery server 4 is stopped (the power is turned off).

Further, the image reception device 6 obtains the key data used for the encryption of the image data or the data for calculating the key, and decrypts the encrypted image data received from the image accumulation/delivery server 4 using the key data specified by the data thus obtained.

### First Embodiment

A first embodiment of the present invention will be explained.

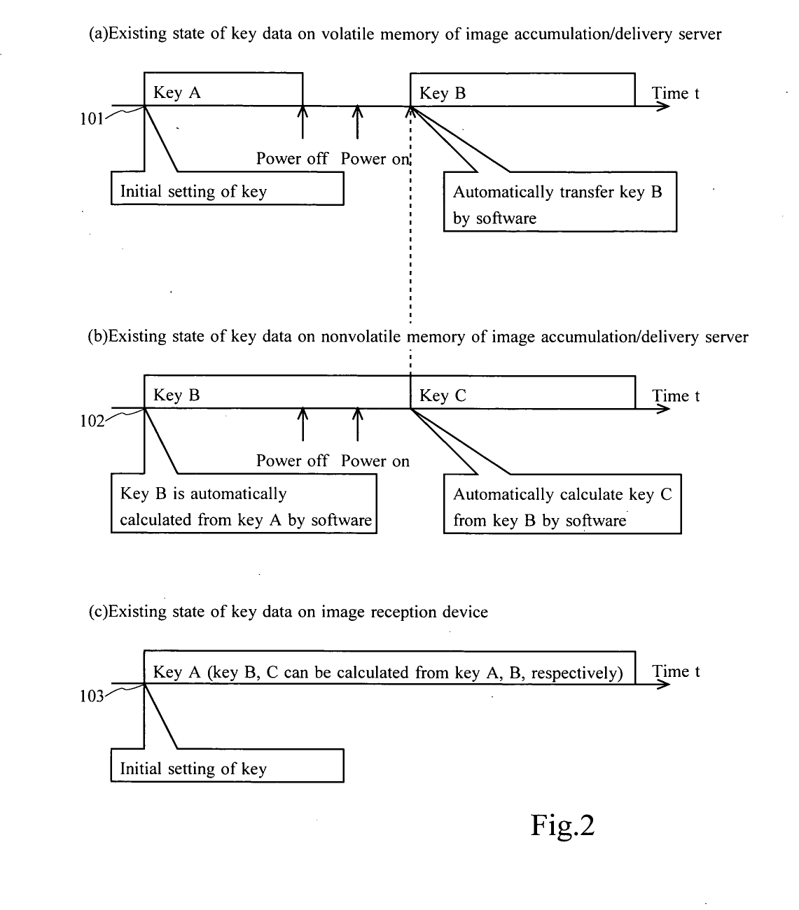

A method (referred to as a start-up key calculation method in the present embodiment) of using a key calculated from a key on a memory device (the volatile memory in the present embodiment), in which information is lost when turning the power off, using a one-way function as the key on the memory device (the nonvolatile memory in the present embodiment) in which information is maintained when turning the power off will be explained with reference to FIGS. 2A through 2C, and 3 through 6.

It should be noted that in the present embodiment, the same one-way function is previously set in both of the image accumulation/delivery server 4 and the image reception device 6, or alternatively, information of the one-way function used by the image accumulation/delivery server 4 is transmitted to and notice the image reception device 6 via the network 11.

FIGS. 2A through 2C schematically show an example of an existing state of the key in the start-up key calculation method. The horizontal axis represents time t.

FIG. 2A shows an existing state 101 of the key data on a volatile memory of the image accumulation/delivery server 4.

FIG. 2B shows an existing state 102 of the key data on a nonvolatile memory of the image accumulation/delivery server 4.

FIG. 2C shows an existing state 103 of the key data on an image reception device 6.

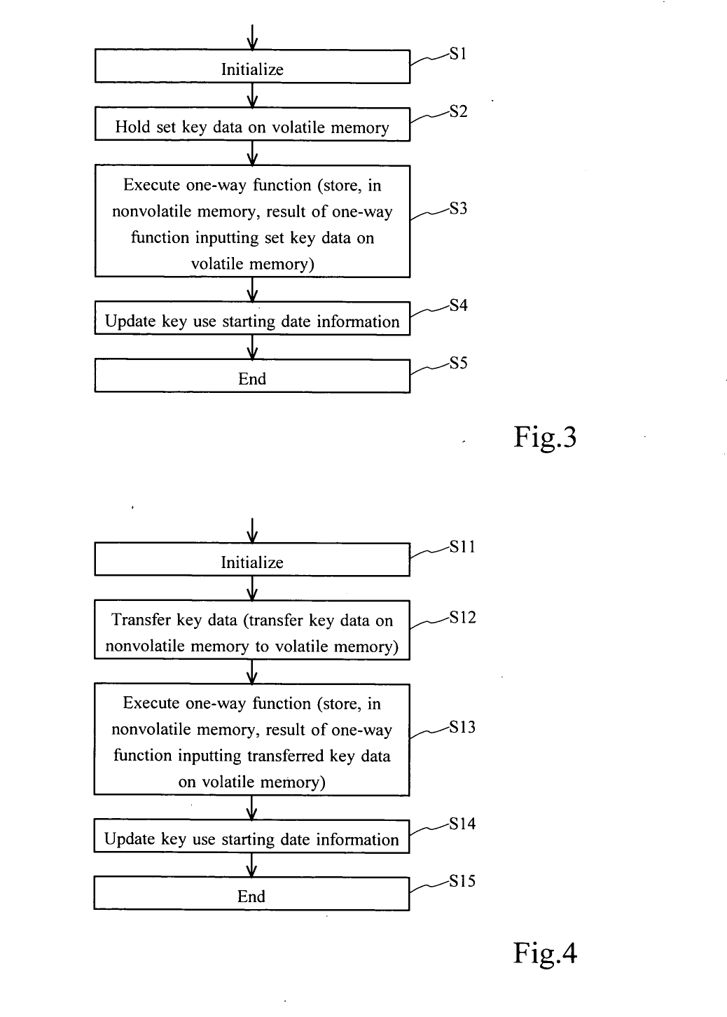

FIG. 3 shows an example of a procedure of a process executed by the image accumulation/delivery server 4 in the initial setting of the image accumulation/delivery server 4 in the start-up key calculation method.

When setting the key in the image accumulation/delivery server 4, after performing initialization (step S1) of the memory and so on in the initialization process, as shown in FIG. 2A, the data of a predetermined key A is held (step S2) on the volatile memory in the process of holding the set key data on the volatile memory.

Subsequently, in the one-way function execution process, the result of the one-way function having the set key data on the volatile memory as the input thereto is stored in the nonvolatile memory (step S3) as the key to be used after the next start-up. Specifically, as shown in FIG. 2B, key B data calculated (automatically by the device) from the key A data by, for example, software is stored in the nonvolatile memory.

Then, in a key use starting date information updating process, the information of correspondence between the number of times of execution of the one-way function and the use starting date of the key for encryption is stored in the nonvolatile memory (step S4).

Finally, a termination process is performed (step S5) to perform releasing the memory and so on.

FIG. 4 shows an example of a procedure of a process executed by the image accumulation/delivery server 4 when starting-up the image accumulation/delivery server 4 in the start-up key calculation method.

When starting-up the image accumulation/delivery server 4 which has been powered on, after initializing the memory and so on in the initializing process (step S11), the key data on the nonvolatile memory is transferred to (stored in) the volatile memory (step S12) in a key data transfer process. Specifically, as shown in FIGS. 2A and 2B, the key B data on the nonvolatile memory is transferred to (stored in) the volatile memory by, for example, software (automatically by the device). Thus, the key B data is removed from the nonvolatile memory.

Subsequently, in a one-way function execution process, the result of the one-way function having the key data on the volatile memory transferred in the key data transfer process described above as the input thereto is stored in the nonvolatile memory (step S13). Specifically, as shown in FIG. 2B, key C data calculated (automatically by the device) from the key B by, for example, software is stored in the nonvolatile memory.

Then, in a key use starting date information updating process, the information of correspondence between the number of times of execution of the one-way function and the use starting date of the key for encryption is stored in the nonvolatile memory (step S14).

Finally, a termination process is performed (step S15) to perform releasing the memory and so on.

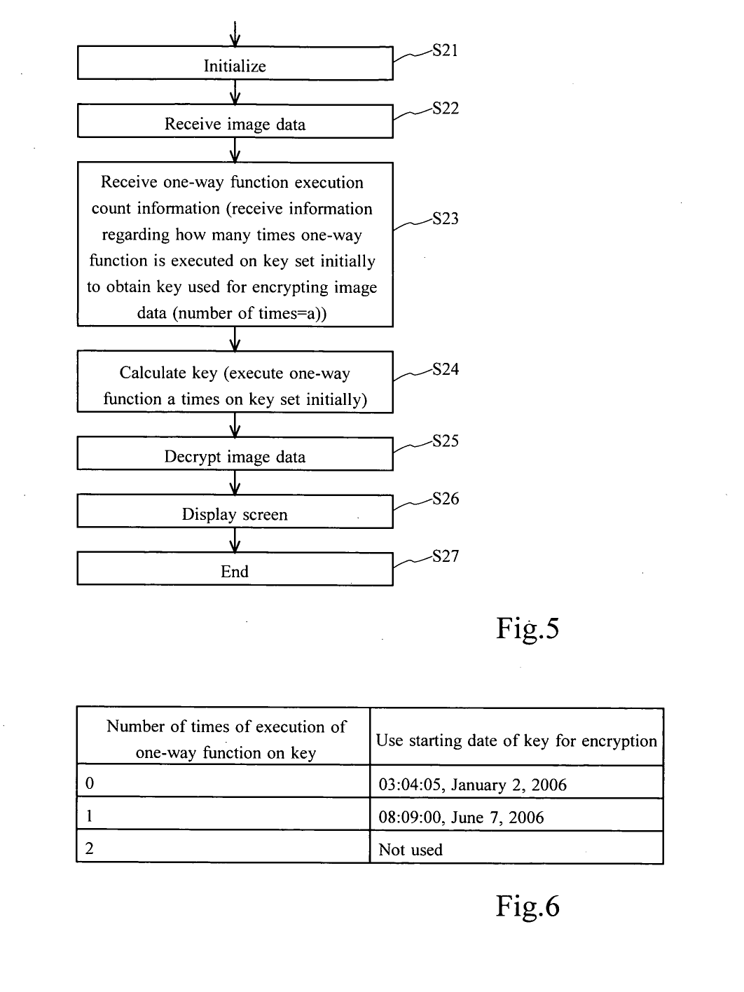

FIG. 5 shows an example of a procedure of a process executed by the image reception device 6 when the image reception device 6 decrypts the encrypted data in the start-up key calculation method.

When the image reception device 6 decrypts the encrypted data, after initializing the memory and so on (step S21) in the initializing process, the encrypted image data is received (step S22) in an image data reception process.

Subsequently, in a one-way function execution count information receiving process, information representing how many times (the number of times is assumed to be “a” in the present embodiment) the one-way function has been executed on the key set initially to obtain the key used for encrypting the present image data is received (step S23). This count information is transmitted from the image accumulation/delivery server 4 to the image reception device 6 via the network 11 together with or separated from corresponding image data, for example.

Here, as shown in FIG. 2C, the image reception device 6 is provided with a key A data set in the initial setting.

Subsequently, in a key calculation process, the desired key is obtained (step S24) by executing the one-way function “a” times on the key A data set initially, based on the key A data set initially and the value “a” of the number of times obtained in the one-way function execution count information receiving process.

Then, in an image data decryption process, the decryption of the encrypted data is performed (step S25) using the key data obtained in the key calculation process described above.

Subsequently, in a screen display process, the image data obtained in the image data decryption process described above is displayed (step S26) on the screen of the image display device 7.

Finally, a termination process is performed (step S27) to perform releasing the memory and so on.

FIG. 6 schematically shows an example of information of the correspondence between the number of times of execution of the one-way function on the key and the use starting date of the key for the encryption in the start-up key calculation method.

In the present embodiment, an example of the correspondence described by the key use starting date information updating process (step S14) after the key C shown in FIG. 2B has been stored is shown.

Specifically, the key is set at 03:04:05, Jan. 2, 2006, the key (key A) on which the one-way function is executed zero times is used from that moment to when the power is turned off, and thereafter, the key (key B) on which the one-way function is executed one time is used after the power has been turned on again at 08:09:00, Jun. 7, 2006.

In the present embodiment, such information of correspondence (information for making the correspondence between the number of times of execution of the one-way function of the key and the use starting date of the key for encryption) is stored in the nonvolatile memory of the image accumulation/delivery server 4.

Here, in the key use starting date information updating process (step S4, step S14), it is enough to obtain the correspondence between the encrypted image data and the number of times of execution of the one-way function on the key used for the encryption, besides the correspondence shown in FIG. 6, a form of making the correspondence between a unique and ascending number which is given at the time of the image data storing (e.g., a frame number) or the like and the number of times of execution of the one-way function in the image accumulation/delivery server 4 can be used as another configuration example. Further, as another configuration example, it is possible to make the correspondence between the information of the number of times of execution of the one-way function and the encrypted image data by storing the encrypted image data with the information of the number of times of execution of the one-way function attached to the top or the bottom thereof in the recording medium 5.

As described above, in the present embodiment, in the image delivery system for recording and then delivering the encrypted image data, when the encryption is performed by the image accumulation/delivery server 4, the key presently used for the encryption is held on the storage device (a volatile memory, in the present embodiment) in which the information is lost by turning off the power of the image accumulation/delivery server 4, the key to be used in the future is held on the storage device (a nonvolatile memory in the present embodiment) in which the information is maintained even if the power of the image accumulation/delivery server 4 is turned off, and when the power is turned on again after the power has once been turned off, the key to be used in the future described above is transferred to the storage device (a volatile memory in the present embodiment) in which the information is lost by turning the power off, and used for encryption.

Further, in the present embodiment, a key calculated from the key on the storage device (a volatile memory in the present embodiment) in which the information is lost by turning the power off using the one-way function is used as the key on the storage device (a nonvolatile memory in the present embodiment) in which the information is maintained even if the power is turned off.

Further, in the present embodiment, the image reception device receives the number of times of execution of the one-way function described above when executing the encryption, thus the key when executing the encryption is calculated.

Therefore, in the present embodiment, by improving the configuration for holding the key used for the encryption, resetting of the key by the user can be eliminated when the power is turned off and on by, for example, the rightful user, further, in the case in which the image accumulation/delivery server 4 or the recording medium 5 is stolen, the leakage of the key data used before can be prevented.

It should be noted that in the image delivery system of the present embodiment, in the image accumulation/delivery server 4 (an example of the image processing device), first storage means is configured by the function of the volatile memory for storing the key data used presently as shown in FIG. 2A, second storage means is configured by the function of the nonvolatile memory for storing the key data to be used in the future as shown in FIG. 2B, and control means is configured by the function that the central processing unit (CPU) provided to, for example, the image accumulation/delivery server 4, using the software, transfers the key data to be used next from the nonvolatile memory to the volatile memory when the power is turned on as shown in FIGS. 2A and 2B.

### Second Embodiment

A second embodiment of the invention will be explained.

A method (referred to as an initial setting key calculation method in the present embodiment) of using a plurality of output values of the one-way function having input values calculated from the key set initially to the image accumulation/delivery server 4 and a plurality of certain values different from each other as the key on the storage device (a nonvolatile memory in the present embodiment) in which the information is maintained even if the power is turned off will be explained.

It should be noted that in the present embodiment, the same one-way function is previously set in both of the image accumulation/delivery server 4 and the image reception device 6, or alternatively, information of the one-way function used by the image accumulation/delivery server 4 is transmitted to and notice the image reception device 6 via the network 11.

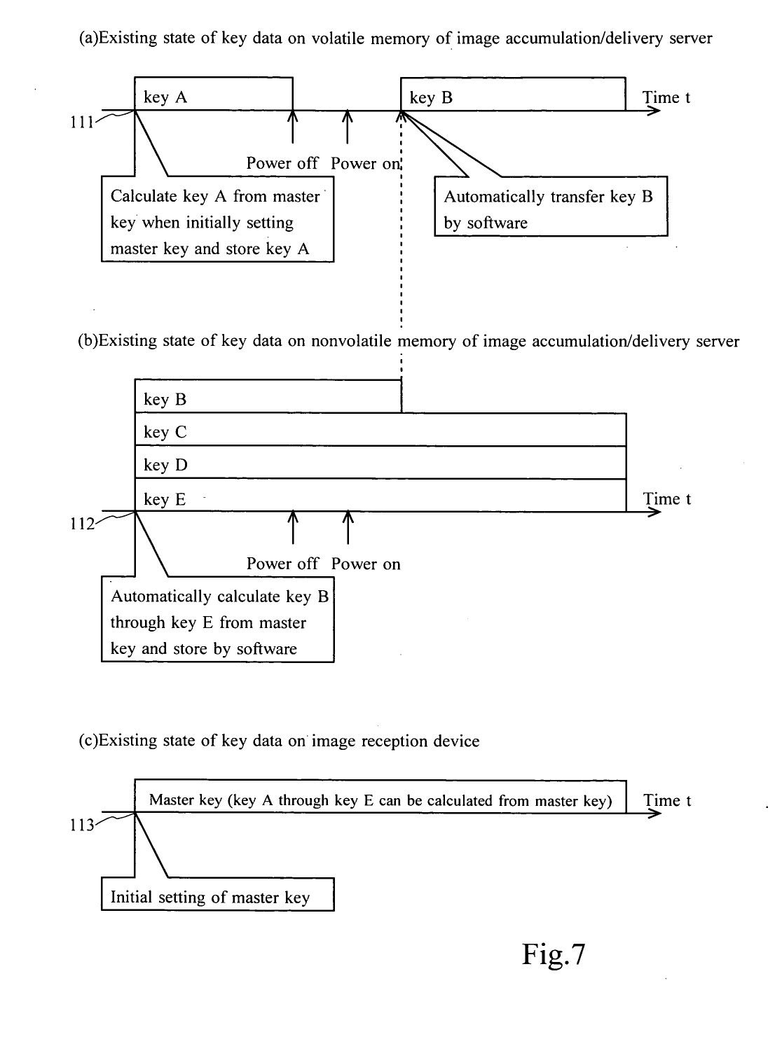

FIGS. 7A through 7C schematically show an example of an existing state of the key in the initial setting key calculation method. The horizontal axis represents time t.

FIG. 7A shows an existing state 111 of the key data on a volatile memory of the image accumulation/delivery server 4.

FIG. 7B shows an existing state 112 of the key data on a nonvolatile memory of the image accumulation/delivery server 4.

FIG. 7C shows an existing state 113 of the key data on an image reception device 6.

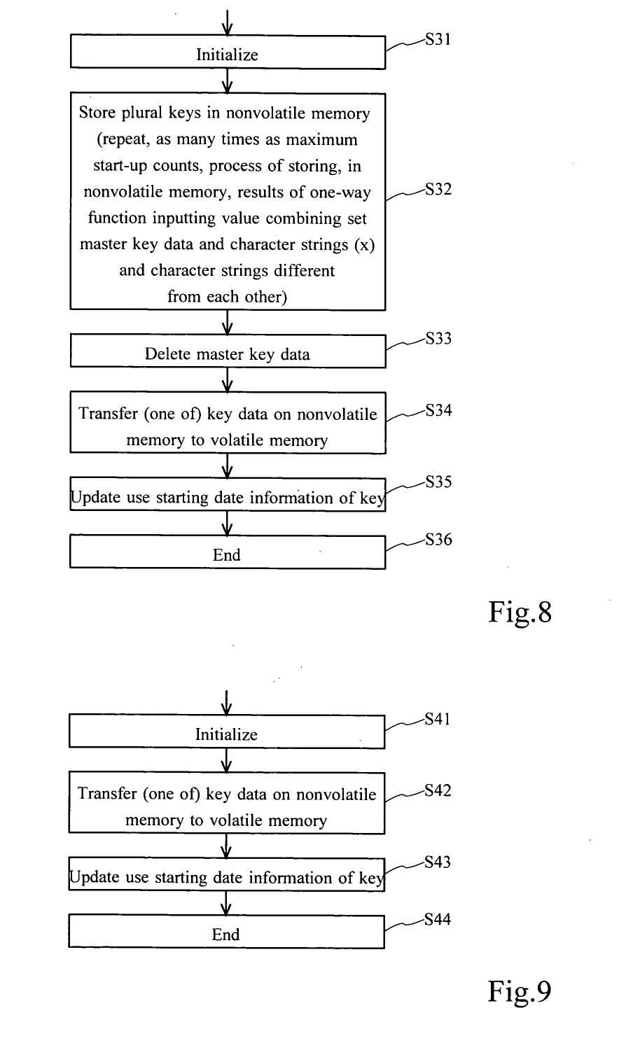

FIG. 8 shows an example of a procedure of a process executed by the image accumulation/delivery server 4 in the initial setting of the image accumulation/delivery server 4 in the initial setting key calculation method.

When setting the key to the image accumulation/delivery server 4, after performing the initialization of the memory and soon in the initialization process (step S31), in a storing process of a plurality of keys to the nonvolatile memory, a process of storing the results of the one-way function using the values obtained by combining the data of the key (referred to as a master key in the present embodiment) set initially and predetermined character strings (x) as the input values, and the used character strings different from each other in the nonvolatile memory is repeatedly performed (step S32) as many times as assumed maximum number of times of starting-up (five times in the example shown in FIGS. 7A through 7C).

Here, in the example shown in FIGS. 7A through 7C, the capital alphabet character string data different from each other, “A”, “B”, “C”, “D”, and “E” is used as the character strings to be combined with the master key, and the five keys, “key A”, “key B”, “key C”, “key D”, and “key E” are calculated using the respective character strings.

Specifically, as shown in FIG. 7B, the data of the key A through key E is calculated (automatically by the device) from the master key and each of the character strings by, for example, software, and the data of the key A through key E is stored in the nonvolatile memory.

It should be noted that as the character string to be combined with the master key data, various kinds can be used, and a numerical value such as number of times of start-up can also be used.

Further, although in the present embodiment the form of combining the master key data and character string is shown, as another example, it is possible to calculate the input value to the one-way function by regarding the master key data as a numeral value and adding the number of times of the start-up therewith.

Subsequently, in master key data deleting process, the master key data which has become unnecessary is deleted (step S33).

Then, in the transfer process of the key data on the nonvolatile memory to the volatile memory, one (in the example shown in FIGS. 7A through 7C, the key A data to be used first) of the key data on the nonvolatile memory is transferred to (stored in) the volatile memory (step S34).

It should be noted that although the keys are transferred in the alphabetical order in the example shown in FIGS. 7A through 7C, the keys can be transferred at random, for example.

Subsequently, in the key use starting date information updating process, the information of the correspondence between the character strings (character strings “A”, “B”, “C”, “D”, and “E” in the present embodiment) used for calculation of the keys and the key use starting date is stored in the nonvolatile memory (step S35).

Finally, a termination process is performed (step S36) to perform releasing the memory and so on.

FIG. 9 shows an example of a procedure of a process executed by the image accumulation/delivery server 4 when starting-up the image accumulation/delivery server 4 in the initial setting key calculation method.

When starting-up the image accumulation/delivery server 4 which has been powered on, after initializing the memory and so on in the initializing process (step S41), similarly to the case of setting the key, in the transfer process of the key data on the nonvolatile memory to the volatile memory, one (e.g., the key B data which comes next in the order) of the key data on the nonvolatile memory is transferred to (stored in) the volatile memory (step S42). Specifically, as shown in FIGS. 7A and 7B, the key B data is transferred from the nonvolatile memory to the volatile memory by, for example, software (automatically by the device). Thus, the key B data is removed from the nonvolatile memory.

Subsequently, in the key use starting date information updating process, the information of the correspondence between the character strings (character strings “A”, “B”, “C”, “D”, and “E” in the present embodiment) used for calculation of the keys and the key use starting date is stored in the nonvolatile memory (step S43).

Finally, a termination process is performed (step S44) to perform releasing the memory and so on.

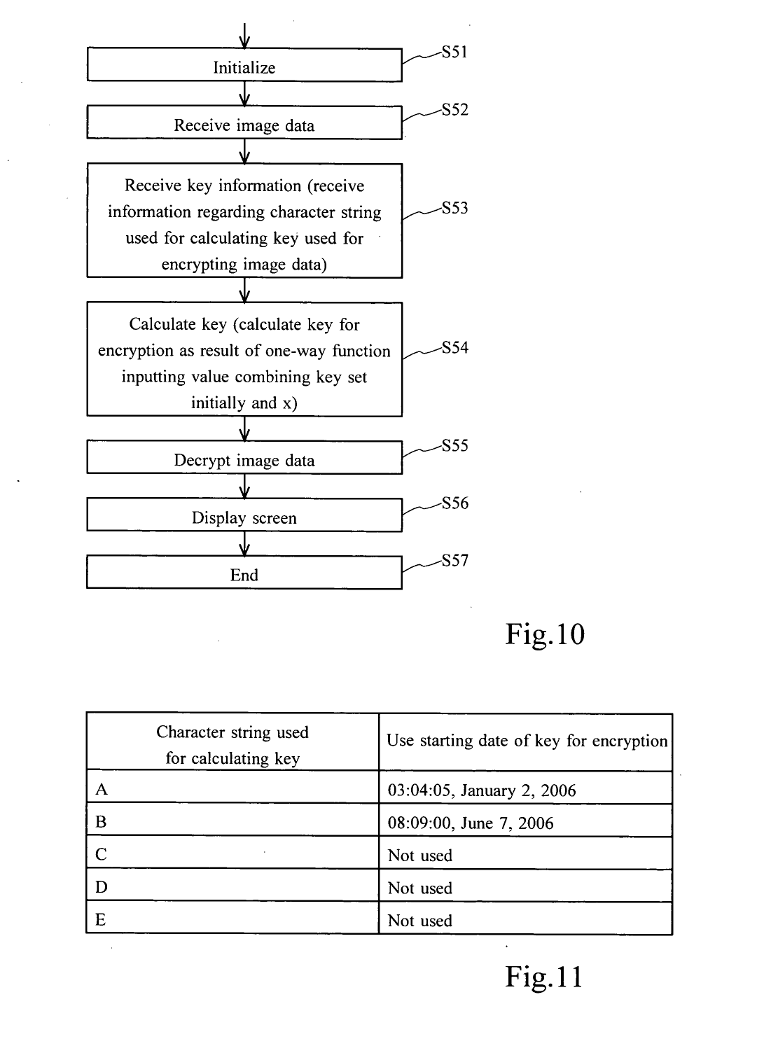

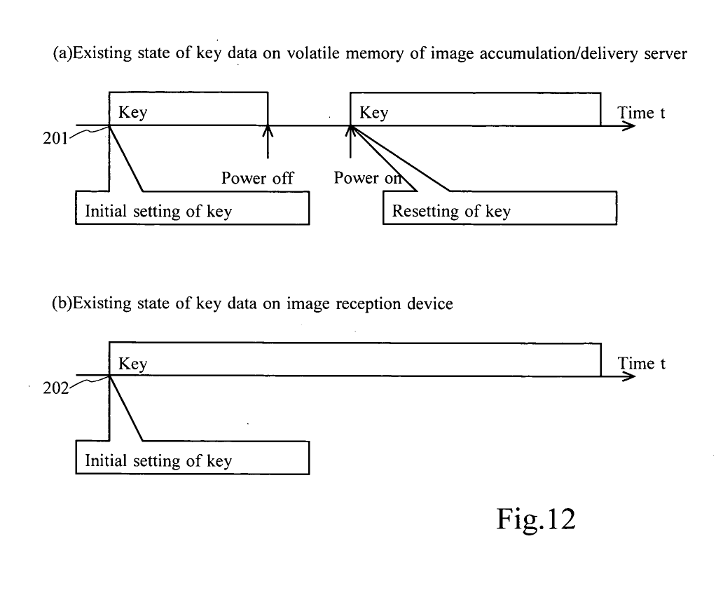

FIG. 10 shows an example of a procedure of a process executed by the image reception device 6 when the image reception device 6 decrypts the encrypted data in the initial setting key calculation method.

When the image reception device 6 decrypts the encrypted data, after initializing the memory and so on (step S51) in the initializing process, the encrypted image data is received (step S52) in an image data reception process.

Subsequently, in the key information receiving process, the information (in the present embodiment, either one of the character strings (x) of “A”, “B”, “C”, “D”, and “E”) necessary for calculating the key used for encrypting the corresponding image data is received (step S53). This character string (x) information is transmitted from the image accumulation/delivery server 4 to the image reception device 6 via the network 11 together with or separated from corresponding image data, for example.

Here, as shown in FIG. 7C, the image reception device 6 is provided with the master key data set and stored in the memory in the initial setting.

Subsequently, in the key calculating process, by inputting the results of the combination of the key (the master key) set initially and the character strings (x) in the one-way function based on the master key and the character strings (x) obtained in the key information receiving process described above, the keys for executing the encryption are calculated (step S54).

Then, in an image data decryption process, the decryption of the encrypted data is performed (step S55) using the key obtained in the key calculation process described above.

Subsequently, in a screen display process, the image data obtained in the image data decryption process described above is displayed (step S56) on the screen of the image display device 7.

Finally, a termination process is performed (step S57) to perform releasing the memory and so on.

FIG. 11 schematically shows an example of information of the correspondence between the character strings (x) used for the calculation of the keys and the use starting date of the key for the encryption in the initial setting key calculation method.

In the present embodiment, an example of the correspondence described by the key use starting date information updating process (step S43) after the key B shown in FIGS. 7A and 7B has been transferred is shown.

Specifically, the key calculated using the character string (x) of “A” is used from 03:04:05, Jan. 2, 2006 to when the power is turned off, and after the power has been turned on again at 08:09:00, Jun. 7, 2006, the key calculated using the character string (x) of “B” is used. Further, the keys calculated using the character strings (x) of “C”, “D”, and “E” respectively are not used.

In the present embodiment, such information of correspondence (information for making the correspondence between the character strings used for calculating the keys and the use starting date of the key for decryption) is stored in the nonvolatile memory of the image accumulation/delivery server 4.

Here, in the key use starting date information updating process (step S35, step S43), it is enough to obtain the correspondence between the encrypted image data and the character string (x) used for calculating the key used for the encryption, besides the correspondence shown in FIG. 11, a form of making the correspondence between a unique and ascending number which is given at the time of the image data storing (e.g., a frame number) or the like and the character string (x) can be used as another configuration example in the image accumulation/delivery server 4. Further, as another configuration example, it is possible to make the correspondence between the information of the character string (x) and the encrypted image data by storing the encrypted image data with the information of the character strings (x) attached to the top or the bottom thereof in the recording medium 5.

As described above, in the present embodiment, in the image delivery system for recording and then delivering the encrypted image data, when the encryption is performed by the image accumulation/delivery server 4, the key presently used for the encryption is held on the storage device (a volatile memory, in the present embodiment) in which the information is lost by turning off the power of the image accumulation/delivery server 4, the key to be used in the future is held on the storage device (a nonvolatile memory in the present embodiment) in which the information is maintained even if the power of the image accumulation/delivery server 4 is turned off, and when the power is turned on again after the power has once been turned off, the key to be used in the future described above is transferred to the storage device (a volatile memory in the present embodiment) in which the information is lost by turning the power off, and used for encryption.

Further, in the present embodiment, the output value of the one-way function with the input of the value calculated from the key (the master key) set initially to the image accumulation/delivery server 4 and a plurality of values (character strings (x) in the present embodiment) different from each other is used as the key on the storage device (the nonvolatile memory in the present embodiment) in which the information is maintained even when the power is turned off.

Further, in the present embodiment, the image reception device 6 receives the values (the character strings (x) in the present embodiment) different from each other when executing the encryption, thus the key when executing the encryption is calculated.

Therefore, in the present embodiment, by improving the configuration for holding the key used for the encryption, resetting of the key by the user can be eliminated when the power is turned off and on by, for example, the rightful user, further, in the case in which the image accumulation/delivery server 4 or the recording medium 5 is stolen, the leakage of the key data used before can be prevented.

It should be noted that in the image delivery system of the present embodiment, in the image accumulation/delivery server 4 (an example of the image processing device), first storage means is configured by the function of the volatile memory for storing the key data used presently as shown in FIG. 7A, second storage means is configured by the function of the nonvolatile memory for storing the key data to be used in the future as shown in FIG. 7B, and control means is configured by the function that the central processing unit (CPU) provided to, for example, the image accumulation/delivery server 4, using the software, transfers the key data to be used next from the nonvolatile memory to the volatile memory when the power is turned on as shown in FIGS. 7A and 7B.

It should be noted here that the configurations of the systems, the devices, and so on according to the invention are not necessarily limited to those described above, but various configurations can be used therefor. Further, the present invention can be provided as a method or a formula of performing the process according to the present invention, a program for realizing such a method or a formula, a recording medium for recording the program, or the like, and further, the present invention can also be provided as various systems or devices.

Further, the application field of the present invention is not necessarily limited to those described above, and the present invention can be applied to various fields.

Still further, as the various processes performed by the systems and the devices according to the present invention, the configuration controlled by the processor performing the control program stored in the read only memory (ROM) in the hardware resource provided with the processor, the memory, and so on, for example, can be used, or each functional means for performing the process can be configured as an independent hardware circuit.

Still further, the present invention can also be understood as the computer readable recording medium such as a floppy (registered trademark) disk or a compact disc (CD)-ROM storing the control program described above or the program (itself), and by inputting the control program to the computer from the recording medium, and making the processor perform the control program, the process according to the present invention can be performed.

What is claimed is:

1. An image processing device for encrypting image data using an encryption key, comprising:
a first storage in which stored information is lost when the image processing device is powered off, and for storing presently used key data;
a second storage in which stored information is maintained when the image processing device is powered off, and for storing key data to be used in the future; and
a controller, in response to the image processing device being switched from a power-off state to a power-on state, for transferring the key data stored in the second storage and to be used next to the first storage to be stored in the first storage.

2. The image processing device according to claim 1 wherein the controller, in response to the image processing device being switched from a power-off state to a power-on state, when transferring to the first storage to be stored in the first storage the key data stored in the second storage and to be used next, stores in the second storage as the key data to be used further next a result of a predetermined one-way function having the key data to be used next as an input.

3. The image processing device according to claim 1
wherein the second storage stores a result of a one-way function as key data corresponding to each of a plurality of different values, the one-way function having a value calculated from key data set initially and each of the plurality of different values as an input,
the controller, in response to the image processing device being switched from the power-off state to the power-on state, transfers the key data to be used next and stored in the second storage to the first storage so as to be stored in the first storage, using a plurality of key data stored in the second storage when initial setting is performed in a predetermined order, and
the image processing device further comprises a transmitter for transmitting information regarding the plurality of values different from each other to another device for decrypting the image data encrypted by the image processing device.

4. An image processing method for an image processing device for encrypting image data using an encryption key, comprising the steps of:
storing key data used presently in a first storage in which stored information is lost when the image processing device is powered off;
storing key data to be used in the future in a second storage in which stored information is maintained when the image processing device is powered off; and
transferring, in response to the image processing device being switched from a power-off state to a power-on state, the key data stored in the second storage and to be used next to the first storage to be stored in the first storage.

5. An encrypted communication system for communicating encrypted image data from a transmission device for encrypting image data using an encryption key to a reception device for decrypting the encrypted image data using the encryption key, the transmission device comprising:
a first storage in which stored information is lost when the transmission device is powered off, and for storing a presently used key data;
a second storage in which stored information is maintained when the transmission device is powered off, and for storing a key data to be used in the future; and
a controller, in response to the transmission device being switched from a power-off state to a power-on state, for transferring the key data stored in the second storage and to be used next to the first storage to be stored in the first storage.

6. The encrypted communication system according to claim 5,
wherein the transmission device and the reception device are previously provided with the same one-way functions,
the reception device includes
a receiver for receiving the encrypted image data and data for calculating the key data used for the encryption from the transmission device,
a key calculator for calculating the key data using the one-way function set previously and the data for calculating the key data used for the encryption and received by the receiver, and
a decryption section for decrypting the encrypted image data received by the receiver using the key data calculated by the key calculator.
